(19) United States
(12) Patent Application Publication
(10) Pub. No.: US 2013/0181434 A1
(43) Pub. Date: Jul. 18, 2013

(54) METHOD FOR MANUFACTURING A SHEET BY MEANS OF COMPREGNATION IN ORDER TO FORM AN AREA MADE TRANSPARENT

(71) Applicants: Eric Prique, Chauffry (FR); Ivan Thierry, Jouy Sur Morin (FR); Philippe Dietemann, Saint Martin d'Heres (FR)

(72) Inventors: Eric Prique, Chauffry (FR); Ivan Thierry, Jouy Sur Morin (FR); Philippe Dietemann, Saint Martin d'Heres (FR)

(21) Appl. No.: 13/769,673

(22) Filed: Feb. 18, 2013

Related U.S. Application Data
(63) Continuation of application No. 13/518,595.

(30) Foreign Application Priority Data
Dec. 23, 2009 (FR) 0959474

(51) Int. Cl. B42D 15/00; B29D 11/00

(52) U.S. Cl. CPC B42D 15/00; B29D 11/0074
USPC 283/72; 264/1.7

(57) ABSTRACT

The present invention relates to a method for manufacturing a sheet including a substrate made of at least one polymer material, comprising the following consecutive steps: a) compregnating at least one area of the substrate such as to form at least one area made transparent; b) providing the substrate with at least two security elements, respectively on the front and back of the substrate, said at least two security elements each being at least partially stacked on said at least one area made transparent and being placed in a marked manner in relation to one another.

### RELATED APPLICATIONS

This application is a continuation of U.S. application Ser. No. 13/518,595, filed Jun. 22, 2012, which is a 371 of International application no. PCT/IB2010/056046, filed Dec. 23, 2010 and claims priority to French application no. 0959474, filed Dec. 23, 2009, all of which are incorporated herein by reference in their entireties.

The present invention relates to security sheets, and more particularly those made from at least one polymeric material.

### PRIOR ART

Security and/or value documents comprising security elements making it possible to protect these documents against attempts at forgery or counterfeiting are in general known.

Certain of these security elements are detectable with the naked eye, in visible light, without use of a special device. These security elements for example comprise colored fibers or strips.

These security elements are described as first level.

Other types of security element are detectable only by means of a relatively simple device such as a lamp emitting in the ultraviolet or the infrared. These security elements for example comprise fibers, strips or particles. These security elements may or may not be visible to the naked eye, being for example luminescent under a Wood's lamp emitting at a wavelength of 365 nm. These elements can also for example be of the thermochromic or photochromic type.

These security elements are described as second level.

Other types of security elements further require a more sophisticated detection device for their detection. These security elements are for example capable of generating a specific signal when they are subjected, simultaneously or otherwise, to one or more external excitation sources. The automatic detection of the signal makes it possible to authenticate the document, if necessary.

These security elements for example comprise tracers taking the form of active material, particles or fibers capable of generating a specific signal when these tracers are subjected to optoelectronic, electrical, magnetic or electromagnetic excitation.

These security elements are described as third level.

The use of plastic materials for the production of these security documents, for example bank notes, is known. Compared to paper documents, plastic documents have the advantage of exhibiting better durability, thanks in particular to their low porosity, and their resistance to moisture, greases or other agents capable of accelerating the ageing of paper documents.

The application GB 2 338 680 for example describes a substrate tier a security document comprising a biaxially oriented transparent polymer film, a relatively opaque polymer film comprising voids and an adhesive layer, between the polymer films, at the front and back whereof there are metallized areas.

The application WO 2008/116796 describes a security document comprising a plurality of polymer films, at least one of the polymer films being non-transparent, axially stretched and comprising voids, with a permanent transparent motif.

To combat the counterfeiting of banknotes by front/back photocopying or using a scanner and a printer, it is possible, by appropriate location in a given zone, to execute motifs on the front and motifs on the back of the note in such a way that these motifs complement one another in transmitted light so as to form a final image or representation, for example a set of graphic lines or alphanumeric characters or an image of a person or an animal, etc. When the note is observed in reflected light, only the motif executed on the observed side is seen, whereas when the note is observed in transmitted light, all the motifs are seen, and therefore complement one another in the final representation. This effect is described by the English term “see-through” or else “print-through” in the case of imprints. According to one modification, identical motifs can be executed matching on the front and back so that in transmitted light an image which is identical to the motifs which are superimposed on one another is observed. These motifs are for example executed by imprints of color flats or by imprints of features or lines or of other shapes.

The use of watermarks which make it possible to authenticate a document by observation in transmitted light and which moreover protect from copying by optical means such as photocopying, photography, or digitization, since the support of the copy does not comprise an integrated watermark, is known.

The use of pseudo-watermarks which reproduce the appearance of a watermark by exhibiting differences in opacity, and which can for example be obtained mechanically by application of pressure with or without application of heat and/or chemically by application of a composition, for example by locally increasing the transparency of the support on which the pseudo-watermark is executed by means of transparentizing substances, is also known.

The application US 2007/0026204 describes a method for executing a pseudo-watermark by embossing onto a plastic material of the TESLIN® type, on which there are laminated different layers of plastic material in order to form a card. However, the use of TESLIN® has disadvantages in that in particular this material does not possess the appropriate properties for execution of a pseudo-watermark having optimal definition.

The application US 2007/0178295 describes a security substrate comprising a polypropylene layer on which embossings can be executed in order to form security elements.

The application EP 0 655 316 describes a method for executing a watermark on a sheet of polymeric material, wherein the sheet is passed between rollers having raised or sunken motifs making it possible to form a marking on the sheet before this is stretched, in such a manner that the marking exhibits light and dark regions on observation in transmitted light. This method has several disadvantages, due in particular to the fact that the marking is executed before the stretching stage, it is not possible to obtain the desired precision and definition in the watermark. Moreover, the stretching stage often leads to a deformation of the watermark and the watermark motif thus obtained is generally not reproducible.

### SUMMARY

There is a need to remedy at least some of the aforesaid disadvantages, in particular to have available new security against forgeries or counterfeiting for security sheets and documents at least partially made of plastic material, which is easily observable with the naked eye while exhibiting a sufficient level of security.

It is also desirable to have available a polymeric material exhibiting properties suitable for the production of such a security element, in particular for the execution of a pseudo-watermark. In particular, there is a need to have available a polymeric material exhibiting improved properties, in particular in terms of compressibility, making it possible to create compactions and zones of lesser opacity locally.

It would also be useful to have available a method making it possible to make one or more zones of a polymeric material transparent enabling the application of security elements on either side of the material.

There is also a need to diversify security sheets in order to produce novel effects in aesthetic terms and/or to obtain augmented security.

The purpose of the invention is to respond to all or part of these needs.

The subject of the invention, according to one of its aspects, is a method for manufacturing a sheet comprising a support, in particular at least partially opaque and/or translucent, made from at least one polymeric material, comprising the successive stages consisting in:

a) compacting at least one zone of the support, in particular by compression of the support, so as to form at least one zone made transparent, and

b) providing the support with at least two security elements respectively at the front and the back of the support, said at least two security elements each being at least partially superposed onto said at least one zone made transparent and being positioned such that the location of one is a function of the location of the other.

The expression “zone made transparent” should be understood in a broad sense, this expression describing a zone which has become transparent or translucent by compaction. In fact, the compaction of a translucent support can make it possible to obtain a transparent zone or a zone which is still translucent but more transparent than the support. Similarly, the compaction of an opaque support can make it possible to obtain a transparent zone or a translucent zone. In other words, the compaction makes it possible to vary the opacity of the zone and in particular to reduce the opacity of the zone. In particular, the opacity of the support can be reduced by compaction by 5%, preferably by 10% and more preferably by 40%, the reduction in opacity being the difference between the opacities measured according to the standard ISO 2471 respectively on the support before compaction and on the zone made transparent (i.e. after compaction).

The support can be opaque or translucent. Its opacity measured according to the standard ISO 2471 in particular lies between 100% (opaque support) and 40%. As a modification, the support can comprise one or more opaque zones and one or more translucent zones.

The compaction of the support makes it possible to reduce its thickness and to pass from a translucent state to a more transparent state, diffusing light less.

By means of the invention, it is possible to execute a zone made transparent on a support, in particular by compression of the latter, and enable the application of security elements so as to cause the appearance of for example a “see-through” effect with the aim of authenticating the security sheet.

The invention makes it possible to execute a zone made transparent from a polymeric material having a layer, in particular a core layer, sufficiently porous to confer compressibility on the material, rendering the local compaction of the support possible, and likewise the creation of zones of lesser opacity. In this way, it is possible to obtain a zone made transparent exhibiting the desired properties, in particular in terms of definition, precision and reproducibility.

The support can be a coextruded support, made from at least one polymeric material comprising a core layer and at least one skin layer, the core layer comprising voids. In this case, the process can comprise, before the stage a), the stage consisting in stretching the support, in particular biaxially.

“Core layer”, also referred to as “base layer” should be understood to mean that this layer of the support is further from the surface of the sheet than the “skin layer”, also referred to as “surface layer”. The skin layer may or may not define an exterior face of the sheet, it being possible for the support to be at least partially covered by a coating intended for example to increase the quality of the zone made transparent.

The compaction can correspond to a compression of the support.

The compression of the support can make it possible to render one or more zones of the support transparent, and allow the appearance of a multitone watermarked effect, in particular in the form of an image in shades of grey.

The compression of the support is in particular facilitated, in the case where the support is coextruded, by the presence of voids of the core layer, the application of a pressure during the compression making it possible in particular to decrease the proportion of these voids and thus to increase the transparency of the support.

The zone made transparent is advantageously entirely situated between the planes respectively defined by the front and back faces of the support before compaction. The zone made transparent may or may not be bounded at least on one side by one of the faces of the support. One of the faces of the zone made transparent can be situated in a plane defined by one of the faces of the support before compaction. At least one of the faces of the zone made transparent can be situated recessed relative to the face of the support situated on the same side, before compaction. The distance which separates the two faces of the zone made transparent can be less than or equal to the distance which separates the two faces of the support before compaction.

The support may be not coated after compaction or be coated before compaction. Thus, it is possible to maintain an optimal rendering of the zone made transparent, since coating of the support after compaction results in a loss of the variations in transparency obtained by compaction.

“Coating” should be understood to mean the deposition of a coating in the liquid state onto the support, in a uniform manner, for example a coating as defined below.

The support may be partially coated, before or after compaction. In other words, the coating may be deposited only partially onto the support.

In particular, the support may be coated onto the whole of at least one of its faces except onto at least one part of the zone made transparent. Such a non-coated part can thus make it possible to render visible the effect of the compaction on the support. In particular, the compaction enables the zone made transparent to appear darker than the rest of the support, in particular owing to a higher concentration of particles, such as pigments, as the thickness of the support is less in this zone.

The support can be colored and/or comprise a luminescent agent. The luminescent agent can be observable under ultraviolet (UV) and/or infrared (IR) radiation. Thus, it is possible to obtain color gradations accentuating the variations in transparency of the zone made transparent. In the case of a coextruded support as defined above, the core layer will preferably be colored and/or will comprise a luminescent agent. In fact, the core layer being compressible owing to the presence of voids, it can make it possible to obtain a better rendering of the color nuances on the zone made transparent.

The Applicant has shown that the poor quality of the pseudo-watermarks executed on the supports of plastic material used until now derived in particular from a lack of compressibility of the supports. Now, a coextruded support as defined above has the advantage of being readily compressible owing to the presence of voids in the core layer. Because of this, it is suitable for the execution of pseudo-watermarks and for any other treatment generating a tactile effect. The support can exhibit pseudo-watermarks equivalent to those obtained on a paper sheet and great sharpness of detail.

Another advantage of such a support is that it enables excellent rendering of the pseudo-watermark as well as good contrast, which makes it possible to clearly depict fine structures thereon, which are difficult for counterfeiters to reproduce.

The compaction, in particular by compression, of the support can be executed to differing extents so as to obtain different levels of transparency over the zone made transparent. For example, one part of the support can be compacted according to a motif, an imprint for example underlying said part of the support, to a greater degree than around this part of the support. This can for example make it possible to obtain a motif complementary to an imprint (for example of the “see-through” type) or casting an imprint into relief.

The method can further comprise a supplementary stage consisting in effecting a compaction in a zone not superposed onto the aforesaid security elements, for example by embossing of the support.

The zone made transparent can correspond to a pseudo-watermark executed on the support. “Pseudo-watermark” is understood to mean an image which appears in the body of the sheet, in particular in the body of one or more layers of the support. The image can in particular appear when viewed by transmitted light.

In order to execute the zone made transparent on the support, for example one or more raised motifs can be used, this or these motifs being present for example on one or more rollers, and a compression of the support be effected by means of the motif or motifs by passing the support in contact with the relief or reliefs, for example by bringing the support into contact with the roller or rollers. The formation of the motif or motifs, for example by gravure on one or more rollers, can be effected so as to cause the appearance of various levels of compaction after compression.

The compaction of the support can be obtained by compression, in particular a compression wherein the support is compressed between a first mould comprising a first prominent motif and a second mould comprising a second prominent motif or as a modification having no motif. The first and second motifs can be identical or different. The first and second motifs can represent at least one part of a pseudo-watermark.

At least one of the first and second motifs can have all its raised areas of the same height. As a modification, at least one of the first and second motifs can have raised areas of variable height, for example with the aim of forming a pseudo-watermark with a multitone effect, as indicated above.

The first motif can have raised areas of the same height or of variable height relative to the raised areas of the second motif.

The heights of the raised areas are for example selected from a set of discrete values, for example at least three values. As a modification, the raised areas can have a height which varies continuously.

The characteristics of the zone made transparent, in particular of the pseudo-watermark, obtained, in particular in terms of definition, precision and reproducibility, can depend on the temperature and pressure, it being possible to select the pressure as a function of the temperature.

The compaction of the support can make it possible to create different levels of transparency on the support, in particular by appropriate selection of the temperature/pressure pair.

The compaction of the support can be effected hot or cold. Preferably, the compaction is effected hot. The temperature utilized during the compaction can for example lie between 60 and 80° C.

The temperature can be less than and close to the melting point of the support or of one of the constituents thereof. Those skilled in the art will preferentially select a temperature lower than said melting point, neither too far so as to enable easier compression of the support, nor too close so that the material is not sticky, the latter in order to avoid any difficulty of implementation. In particular, in the presence of a support made at least partially of polyethylene, the temperature can be less than and close to the temperature of the polyethylene (PE). In this way, it is possible to facilitate the compaction or even the deformation of the support. “Close” for example designates a value lying between 40 and 70% of the melting point of the support.

The pressure applied during the compaction can be selected on the basis of the degree of transparentization desired. In particular, the higher the pressure is, the more the compaction creates transparency. The pressure can for example lie between 150 and 300 bar.

The period during which the compression is applied can be variable. The period can for example be less than or equal to 5 seconds.

The temperature, the pressure and/or the duration can be adapted in order in particular to obtain an optimal rendering of the security elements at the front and back of the support, in particular in the form of complementary imprints, and/or optimal contrast relative to the compressed zone of the support, while taking care not to weaken the support.

To raise the temperature, the support and/or the moulds utilized, for example the roller or rollers with imparted relief, can be heated.

The first and/or the second mould can for example be made of an absorbent paper, whether or not thick, a layered cardboard, whether or not hard, a piece of Bakelite, a metal piece, rubber, or a polymer, for example polyurethane, inter alia.

The compaction can make it possible to obtain definition close to that desired for a pseudo-watermark. In particular, the compaction according to the invention can make it possible to obtain isolated compacted points of major dimension less than 200 μm, for example less than or equal to 50 μm.

The support can be made of one or more materials, selected from:

1) resins polymerized by addition such as:

a) polyolefin resins, optionally having variable densities and variable degrees of branching such as for example polyethylene, polypropylene, polymethylpentene, and mixtures thereof,

b) elastomer resins such as for example ethylene-propylene-diene monomers, poly(acrylonitrile-butadiene-styrene), poly(styrene-butadiene-styrene), polybutadiene, polyisoprene, and mixtures thereof;

c) vinylic resins such as for example poly(vinyl chloride), poly(vinyl acetate), poly(ethylene-vinyl acetate), poly(ethylene-vinyl alcohol), and mixtures thereof,

d) halogenated resins such as for example poly(vinyl chloride), poly-chloroprene, poly(vinylidene chloride), poly and mixtures thereof,

e) styrene resins such as for example polystyrene, poly(styrene-acrylonitrile), poly(styrene-butadiene-styrene), and mixtures thereof,

f) acrylic resins such as for example poly(methyl methacrylate), polyacrylonitrile, poly(acrylonitrile-butadiene-styrene), poly(ethylene-methyl acrylate), and mixtures thereof,

g) ionomer resins,

2) resins polymerized by condensation such as:

a) polyester resins such as for example poly(ethylene terephthalate), poly-(butylene terephthalate), polyethylene glycol terephthalate), alkyds, and mixtures thereof,

b) polyamide resins,

c) polycarbonate resins,

d) polyurethane resins,

e) polyimide resins,

f) polyacetal resins, such as for example polyvinylbutyral,

g) polyether resins, such as for example polyoxymethylene,

h) epoxy resins,

i) aminoplast resins,

j) phenolic resins,

k) silicone resins,

3) resins derived from natural cellulose such as:

a) cellulose acetate (also referred to as viscose)

The invention also relates to an article, in particular a security or value document or a packaging device, comprising a sheet obtained by the method as defined above.

In particular, the article can be selected from: an identity document, a means of payment such as a check or a bank note, an identity card, a passport page or booklet, a visa, a ticket, a protective or authenticating label, a traceability label, headed paper or paper for advertising purposes, inter alia.

A further subject of the invention, independently or in combination with the foregoing, is a method for manufacturing a sheet comprising a support, in particular at least partially opaque and/or translucent, made of at least one polymeric material, in particular a coextruded support made of at least one polymeric material comprising a core layer and at least one skin layer, the core layer comprising voids, comprising the stage consisting in compacting at least one zone of the support so as to cause the appearance of a multitone watermarked effect exhibiting different degrees of light and dark zones.

In particular, the zone of the support can be compacted on the basis of a raster.

The expression “raster” in the sense of the present invention should be understood in a broad sense which covers all types of raster or pseudo-raster, comprising in particular a juxtaposition of light zones and dark zones, distinguishable from one another, where the shape of these light zones and these dark zones is not limited to one particular shape but can be any whatever.

In the present invention, the expressions “light zones” and “dark zones” designate zones such that the opacity of the “light zones” is lower than the opacity of the “dark zones”, the opacity being measured according to the standard ISO 2471, as described above.

For example, the raster can comprise a set of raster elements, for example raster points and/or raster lines, whether or not parallel. The size and density of the raster elements and/or the spacing between the raster elements can be variable or constant. The raster can form a succession of light and dark zones, for example white and black.

A raster element can represent a symbol, an alphanumeric character, a text, an ideogram or an object, inter alia.

The raster can be amplitude-modulated. Amplitude modulation should be understood to mean that the light zones are of greater or lesser size depending on the optical density to be reproduced. The raster can comprise raster lines with a constant line count, lying for example between 5 and 20 l/cm.

The raster can be frequency-modulated. Frequency modulation should be understood to mean that the light zones are more or fewer in number depending on the optical density to be reproduced.

A further subject of the invention, independently or in combination with the foregoing, is a method for manufacturing a sheet comprising a support, in particular at least partially opaque and/or translucent, for example a coextruded support made from at least one polymeric material comprising a core layer and at least one skin layer, the core layer comprising voids, made from at least one polymeric material, comprising the successive stages consisting in:

a) coating the support,

b) compacting at least one zone of the support so as to form at least one zone made transparent.

A further subject of the invention, independently or in combination with the foregoing, is a method for manufacturing a sheet comprising a support, in particular at least partially opaque and/or translucent, for example a coextruded support made from at least one polymeric material comprising a core layer and at least one skin layer, the core layer comprising voids, made from at least one polymeric material, comprising the stage consisting in:

a) compacting at least one zone of the support so as to form at least one zone made transparent without coating of the support after compaction.

The invention can be better understood on reading the description which is to follow, of practical examples not limiting thereof, and on examination of the schematic and partial drawings attached, on which:

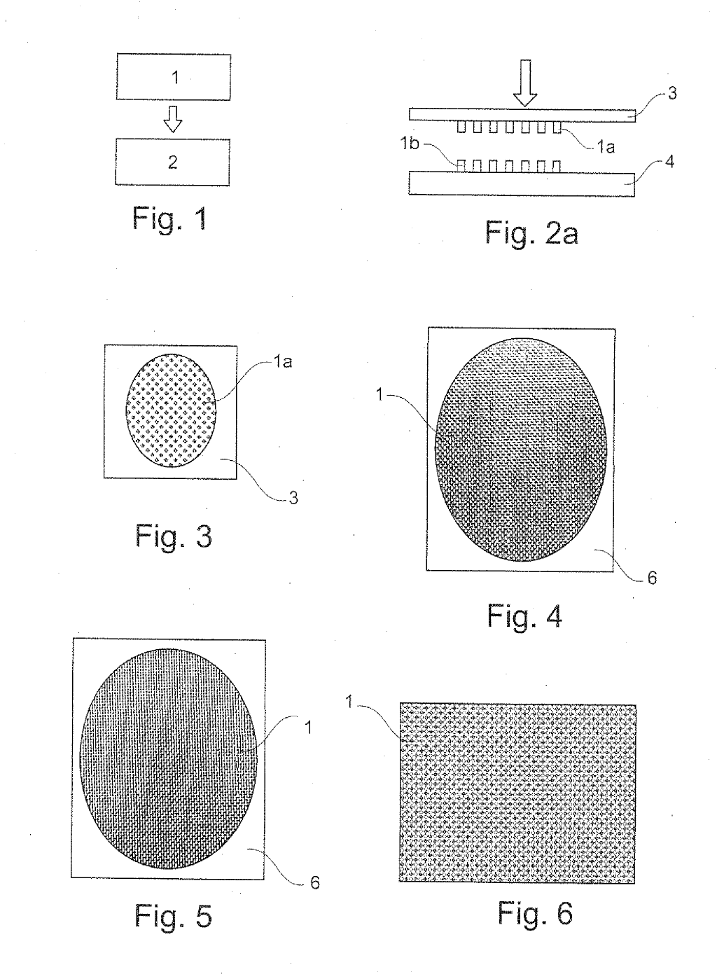

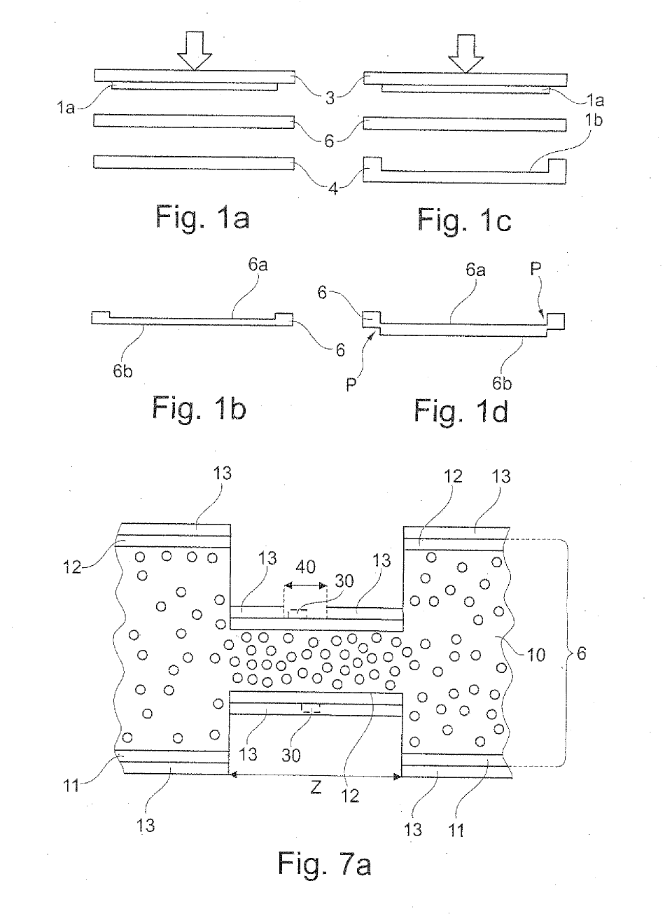

FIGS. 1a and 1b illustrate a method of compaction of a support by compression,

FIGS. 1c and 1d illustrate a method of compaction of a support by embossing,

FIG. 1 illustrates stages of a manufacturing method according to the invention,

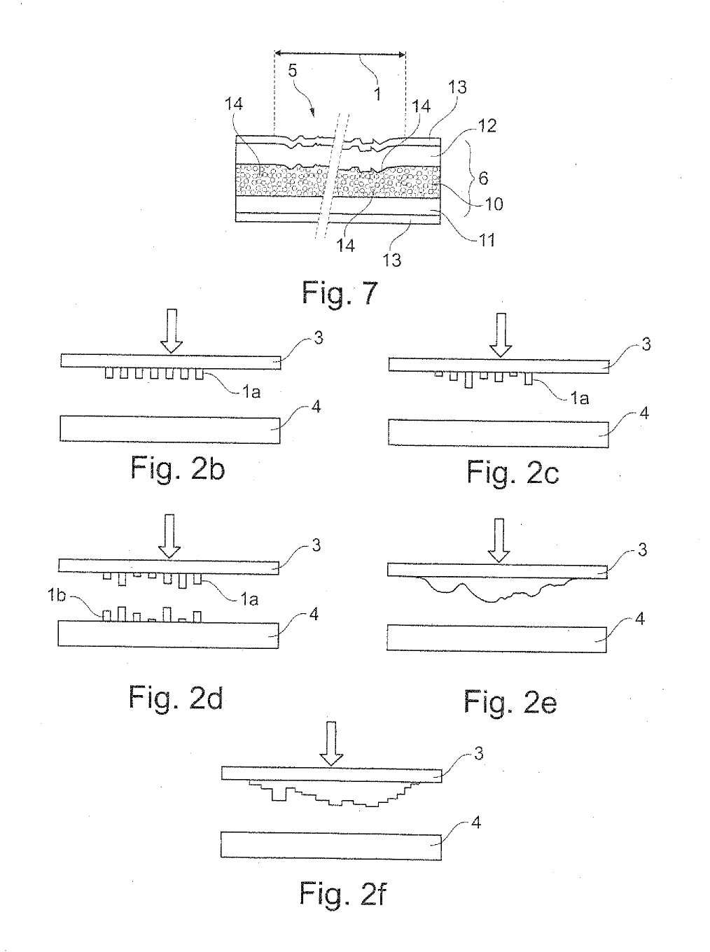

FIGS. 2a to 2f represent, in cross section, examples of first and second moulds enabling the execution of a pseudo-watermark on a support according to the invention,

FIG. 3 represents, in front view, an example of a motif for forming a pseudo-watermark on a support according to the invention,

FIGS. 4 and 5 represent, in front view, the observation of the pseudo-watermark the motif whereof is represented on FIG. 3, respectively in reflected light and in transmitted light,

FIG. 6 represents, in front view, a detail of the pseudo-watermark of FIG. 5,

FIG. 7 represents, in cross section, an example of a sheet according to the invention,

FIG. 7a represents, in cross section, another example of a sheet according to the invention,

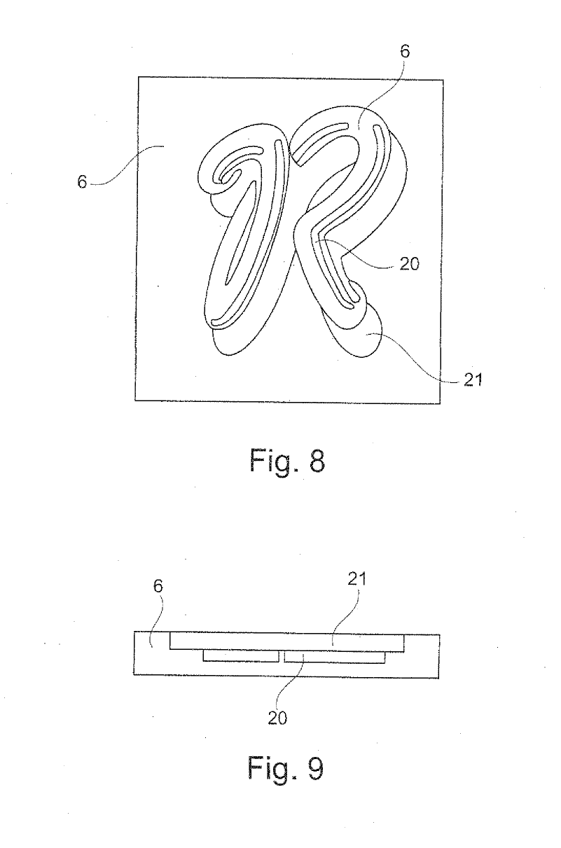

FIG. 8 represents, in front view, another example of a support comprising a pseudo-watermark executed according to the invention,

FIG. 9 is a cross section view of FIG. 8,

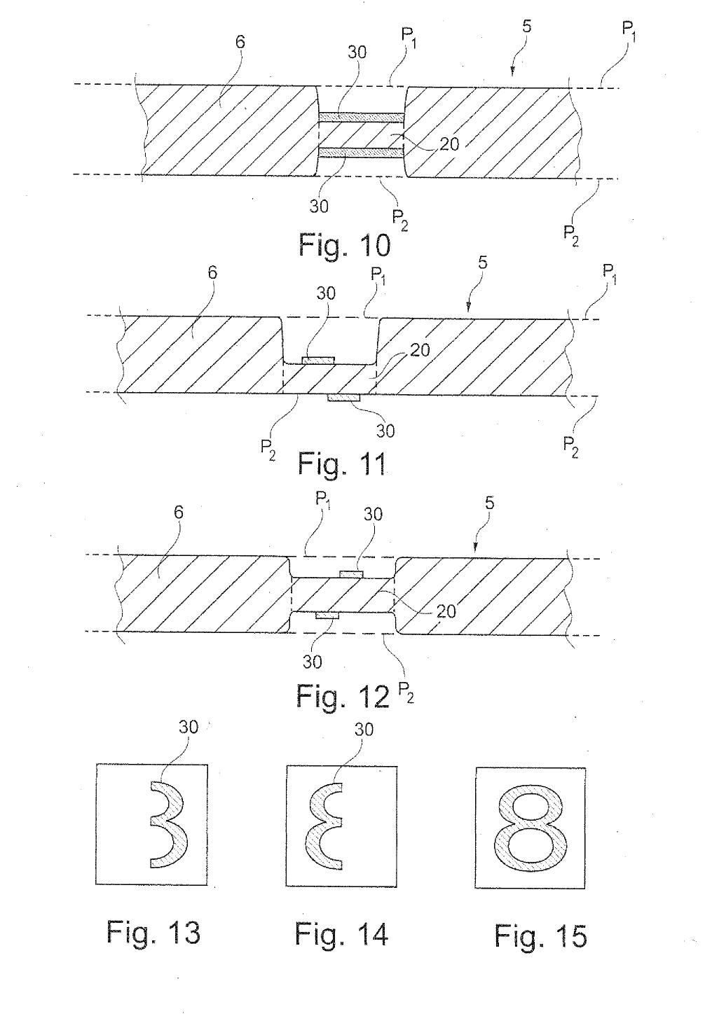

FIGS. 10 to 12 represent examples of security sheets executed according to the invention,

FIGS. 13 and 14 represent respectively front and back views of the security sheet of FIG. 12,

FIG. 15 represents, in front view, the observation in transmitted light of the security sheet of FIG. 12, and

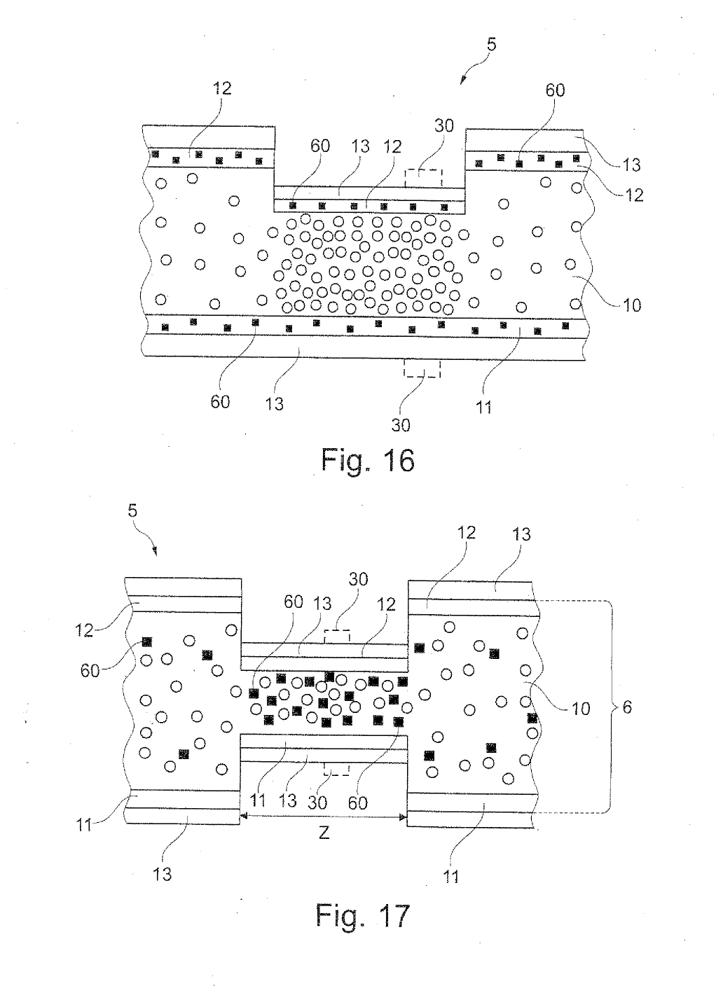

FIGS. 16 and 17 represent, in cross section, other examples of sheets according to the invention incorporating marking particles.

In the figures, for the clarity of the diagrams, the elements have not always been represented with regard to the actual proportions.

FIGS. 1a and 1b illustrate a method of compaction of a support 6 by compression.

As illustrated in FIG. 1a, the support 6 is placed between a first mould 3 comprising a raised motif la and a second mould 4 comprising a planar surface.

The compaction of the support 6 then makes it possible to obtain a compacted support 6 comprising a first face 6a exhibiting a sunken motif corresponding to the raised motif 1a of the first mould 3, and a second planar face 6b, as can be seen in FIG. 1b.

FIGS. 1c and 1d illustrate a method of compaction of a support 6 by embossing.

As illustrated in FIG. 1c, the support is placed between a first mould 3 comprising a raised motif 1a and a second mould 4 comprising a sunken motif 1b.

The compaction of the support 6 then makes it possible to obtain a compacted support 6 comprising a first face 6a exhibiting a sunken motif corresponding to the raised motif 1a of the first mould 3, and a second face 6b exhibiting a raised motif corresponding to the sunken motif 1b of the second mould 4. Moreover, zones of lesser thickness P are formed on the support 6, also referred to as “pinch zones”.

The invention relates, in practical examples, to the treatment of a coextruded support, made from at least one polymer comprising a core layer and at least one skin layer, the core layer comprising voids, in order to make a zone of augmented transparency.

As illustrated in FIG. 1, in a first step 1, the support can be stretched, preferably biaxially.

Then in a second stage 2, a compression, preferably hot, of the support is effected.

The compression can be effected with first and second moulds, the first mould comprising a first raised motif and the second mould comprising a second raised motif, the motifs being representative of the pseudo-watermark to be executed.

An example of first and second moulds 3 and 4 is shown in cross section in FIG. 2a.

The first mould 3 can comprise a first raised motif 1a the layout whereof corresponds to the pseudo-watermark 1 which it is desired to have appear on the coextruded support, and the second mould 4 comprises a second motif 1b the layout whereof also corresponds to this pseudo-watermark 1.

The compression is effected by placing the support between the first mould 3 and the second mould 4. The hardness of the first and second moulds 3 and 4 can be selected depending on the tactile effect and/or the contrast which it is desired to obtain.

In the examples of FIGS. 2b and 2c, only the first mould 3 comprises a first raised motif 1a, the second mould 4 having no raised area.

The heights of the raised areas of the first motif 1a can be constant, as shown in FIG. 2b, or variable, as shown in FIG. 2c. A height difference in the raised areas of the first mould 3 can enable the obtention of multitone watermarks with different levels of transparency. The greater the height of a raised area, the greater the transparency created on the support.

In the practical example of FIG. 2d, the first and second moulds 3 and 4 each comprise first and second raised motifs 1a and 1b, the heights of the raised areas being variable. The heights of the motifs can be selected discrete values, for example between 2 and 10 height values. The layout of the raised areas can correspond to the raster points of a raster image.

FIGS. 2e and 2f represent embodiments of a first mould 3 comprising a first raised motif 1a with a single raised area the heights whereof vary continuously. The second mould 4 could also exhibit a second motif 1b provided with a similar raised area.

FIG. 3 shows, in front view, the pattern defined by the raised areas of the first mould 3 of FIG. 2. The pattern corresponding to the second mould 4, not shown, can be identical. As can be seen in FIG. 3, the support can thus be compacted in accordance with a raster, comprising for example raster points.

FIG. 4 shows, in front view under reflected light, the pseudo-watermark 1 executed from the first and second moulds 3 and 4 of FIG. 2.

FIG. 5 shows, in front view under transmitted light, the pseudo-watermark 1 obtained from the first and second moulds 3 and 4 of FIG. 2.

It can at the same time be seen on FIGS. 4 and 5 that the precision and the contrast of the pseudo-watermark 1 make it possible to clearly distinguish the pattern formed by the pseudo-watermark 1.

A compaction by compression operated as described above can facilitate the obtention of a relatively high transparency over the whole extent of the pseudo-watermark, unlike an embossing which would facilitate the obtention of a higher transparency essentially at the edges of the pseudo-watermark.

Moreover, a compaction by compression operated as described above can enable the obtention of a relatively high transparency over the whole extent of the pseudo-watermark, while retaining better mechanical strength in the zone of the pseudo-watermark than if the compression had been uniform over the whole zone of the pseudo-watermark. In fact, the raised area of FIG. 2a can for example make it possible to retain non-compressed zones (between the raised areas) which retain their thickness.

In practical examples, the compaction is effected by means of a plate press, for example of the Titan® brand.

The sheet utilized is for example POLYART® P3, having a grammage of 90 g/m² for example.

The sheet utilized can also be PEPPART®, having a grammage of 95 g/m².

The selection of POLYART® is preferable since PEPPART® is less porous or less opaque, so that the differences in opacity are less easy to observe.

A combination comprising POLYART® selected for its suitability for compression on a base of PEPPART® selected for its mechanical strength can also be utilized.

The pressure applied can be selected from the values mentioned above. The higher the pressure is, the higher will be the transparency obtained.

The temperature can be selected from the values mentioned above. However, the temperature must not exceed too high a value which would risk creating undesirable deformations on the sheet. The temperature can for example be equal to 80° C.

FIG. 6 shows, in front view, a detail of the pseudo-watermark 1 of FIG. 5.

In this figure, it can be seen that the transparency obtained is such that it can make it possible to see simultaneously, with transmitted light, the parts of the pseudo-watermark 1 due to the motifs 1a and 1b.

FIG. 7 represents, in cross section, an example of a sheet 5 according to the invention, comprising a coextruded support 6. In this example, the compaction is effected after coating with a coating 13. As a modification, the compaction can be effected before coating.

The support 6 can comprise, as illustrated, a core layer 10 and on either side thereof skin layers 11 and 12.

The support 6 may be not completely opaque.

The base layer 10 comprises voids 14 which can result from stretching of the core layer by extrusion, for example bi-axial stretching.

The support 6 can be covered at least partially, on one face at least, by a coating 13.

One or more pseudo-watermarks 1 are executed on the sheet 5, for example on the sheet comprising a coating 13, the latter for example having been applied on one of the skin layers at least in order to confer specific properties on it, such as described below.

For example, the coating can comprise a binder, such as a mixture of polymers of butyl acrylate, styrene and acrylonitrile, and fillers such as a silicoaluminate and/or aluminum hydroxide.

The sheet can also comprise a coating having dirt-repellent and/or durability-improving properties, being for example as described in the application EP 1 319 104. For example, one of the skin layers at least of the support can be covered with a transparent layer comprising a colloidal silica and a binder, for example a polyurethane.

The support and/or the sheet can also comprise a protective varnish.

The support 6 can be made from at least one polymeric material, preferably at least one polyolefin, for example a polyethylene or a polypropylene.

The core layer 10 can for example comprise a mixture of thermoplastic orientable polyolefin with at least one resinate, in particular metal resinate, for example based on calcium and zinc, in a quantity of 2 to 50% by weight relative to the weight of the mixture, the polyolefin being for example a high density polyethylene. The resinate can comprise a separate phase, uniformly distributed in the olefinic polymer, as disclosed in EP 470 760 A2.

The composition of the core layer can for example be that given in EP 0470 760 A2, namely (in proportions by weight):

| | |
|---|---|
| HD polyethylene (copolymer) | 100 |
| Resinate, in particular calcium-zinc | 5-15 |
| Polystyrene | 4.5-5.5 |
| HD polyethylene (homopolymer) | 17.5-21 |
| Calcium carbonate | 15-25 |
| Titanium dioxide | 5-10 |
| Styrene-butadiene copolymer | 0-1.0 |
| Calcium oxide | 0.4-1.0 |

The support has for example the following formula:

Base Layer (for Example about 80 μm in Thickness):

| Constituent elements | Parts |
|---|---|
| HDPE copolymer | 100 |
| HDPE homopolymer | 17.6 |
| Polystyrene | 4.8 |
| Colophony resin | 6.0 |
| Styrene-butadiene-styrene copolymer | 0.6 |
| CaCO₃ | 21.0 |
| TiO₂ (rutile) | 5.8 |
| Antistatic agents, antioxidants, . . . | 1.4 |

Skin Layers (for Example about 8 μm in Thickness):

| Parts | Constituent elements |
|---|---|
| 100 | HDPE copolymer |
| 9.9 | HDPE homopolymer |
| 15 | TiO₂ (rutile) |
| 0.1 | Calcium stearate |

Each skin layer 11 or 12 can comprise a polyolefin and an inorganic filler, in particular a silica. Each skin layer 11 or 12 can comprise from 10 to 50% by weight of inorganic filler, relative to the weight of the mixture.

At least one of the skin layers can comprise at least three thermoplastic polymeric materials including a rubbery polymer, at least two of the materials having at least a certain degree of incompatibility.

At least one skin layer can thus comprise a composition comprising a high density polyethylene and a low density polyethylene or a copolymer of propylene and a rubbery polymer. The latter can be selected from thermoplastic copolymers of butadiene and styrene, copolymers of isobutylene and isoprene and terpolymers of ethylene, propylene and diene.

The core layer 10 can be thicker than each of the skin layers 11 or 12. The core layer 10 can have a thickness greater than 10 μm, better 50 μm, still better 75 μm and each skin layer a thickness lower than 50 μm, better 15 μm, still better 10 μm. The support 6 can have a total thickness lying 50 and 150 μm, preferably between 70 and 120 μm, for example.

The core layer 10 comprises voids 14, as indicated above. The voids content of the support 6 can lie between 2 and 7%, preferably between 4 and 6%, relative to the total volume of the support. The skin layers 11 and 12 are preferably free from voids opening onto their surface.

The determination of the voids content of the support can in particular be effected after cutting of the support by ion beam (argon ions for example), which makes it possible to limit the appearance of scratches, infills, tears or compressions on the support and to preserve the morphology of the support, thus facilitating the determination of the porosity.

After the cut has been effected, the observation can be performed by electron microscope, in particular by means of a scanning electron microscope, for example of the ESEM Quanta 200 type. It is then possible to distinguish the different layer of the support, by the core layer and the skin layers, the porosities and any security elements.

The voids content can be calculated by the ratio between the total area of the voids present on the cut and the total area of the cut, using the following formula:

$$φ = 〈 \overline{{P}_{s}} 〉 = \frac{{S}_{void}}{{S}_{cut}}$$

The coextrusion of the different layers of the support can be effected at a temperature lying for example between 150 and 250° C.

The surface of the support can be subjected to oxidation by electrical discharge treatment of the corona type. Such a treatment makes it possible to obtain a polar surface as well as the wettability required for readily accepting the inks and coatings that may subsequently need to be applied onto the support.

The application EP 0470 760 discloses methods for manufacture of a support which can be suitable for the invention.

FIG. 7a represents, in cross section, another example of a sheet 5 according to the invention, comprising a support 6.

In this example, the face 6b of the support 6 is totally covered by a coating 13, and the face 6a of the support 6 is also totally covered by a coating 13 except in one part 40 of the zone made transparent Z. The non-coated part 40 can make it possible to make the effect of the compaction on the support 6 visible. In particular, the compaction enables the zone made transparent Z to appear darker than the rest of the support 6, in particular owing to the higher concentration of particles, such as pigments, since the thickness of the support 6 is less in this zone Z.

The sheet 5 can comprise security elements 30, on each of its faces, front and back, at the zone made transparent Z. At least one security element 30 can for example be situated at the non-coated part 40.

### Superposed Security Elements at the Zone Made Transparent

The security elements, placed located on the support in at least partial super-position with the zone made transparent, may or may not be superposed on one another.

The security elements can correspond to imprints executed for example by an intaglio, offset, laser, inkjet, photogravure, silk-screen, typographic or micro-lithographic printing process.

The observation of the faces of the support in reflected light can only make it possible to observe security elements placed on this face of the support.

The security elements can be complementary such that the observation of the support in transmitted light can make it possible to observe a motif formed by the combination of the complementary security elements.

The security elements in the form of imprints can for example make it possible to obtain a “moiré effect” on viewing by transmitted light.

The moiré effect can for example reveal a motif produced by the superposition of two imprints, for example by the juxtaposition of lines of the two imprints.

The security elements in the term of imprints can also for example make it possible to obtain “combinative effects” on viewing by transmitted light.

A combinative effect results from the observation by transmitted light of a particular motif which is the result of the combination of two motifs one appearing on either side of the support, a first motif can be printed on the front of the support and a second motif can be printed on the back of the support. On observation by transmitted light, a third motif can then be observed, resulting from the combination of the first and second motifs.

FIGS. 10 to 12 show examples of sheets 5 made according to the method of the invention.

The sheet 5 shown in FIG. 10 comprises a zone made transparent 20 and two security elements 30 superposed for example totally at the zone made transparent. The zone made transparent 20 is for example obtained by compression of the support 6 between a first and a second mould each comprising raised areas, as described above.

In the example of FIG. 11, the sheet 5 comprises a zone made transparent 20 obtained for example by compression of the support 6 between a first mould comprising reliefs and a second mould with no raised areas. The security elements 30 and the zone made transparent 20 are for example partially superposed.

In the example of FIG. 12, the security elements 30 are not superposed on one another.

In the examples of FIGS. 10 to 12, the security elements 30 can for example make it possible to observe a “see-through” effect by observation of the sheet 5 in transmitted light. Further, the zones made transparent 20 are situated between the planes P₁ and P₂ respectively defined by the front and back faces of the support 6 before compaction.

FIGS. 13 and 14 show, in front view, examples of security elements 30 which can appear respectively at the front and back of the security sheet 5 represented in FIG. 12.

In reflected light, the observation of the front or the back of the sheet 5 only makes it possible to see one half of the numeral “8”, as can be seen in FIGS. 13 and 14. In transmitted light, the observation of the sheet 5 makes it possible to see the numeral “8” as a whole, as can be seen in FIG. 15, by a “see-through” effect between the security elements 30.

The exterior contour of the numeral “8” could, if necessary, be rendered transparent to a greater degree than the interior of the numeral “8”, for example so as to create, on observation, an effect of raising of the numeral “8”.

The support can possibly comprise at least any one other additional security element, different from said at least two security elements.

### Additional Security Elements

All of the first, second or third level security elements can be utilized in the context of the present invention. At least one skin layer and/or the core layer and/or the coating of the support can comprise at least one such first, second or third level security element.

The core layer and/or at least one skin layer and/or the coating can comprise a security element in the body and/or on its surface.

The respective security elements of the skin, core and coating layers can all be different from one another or, as a modification, all identical,

The core layer can exhibit a concentration of security elements higher than for the other layers, owing to its distance from the surface.

The security elements can be incorporated into the support before extrusion of the latter, so as to be dispersed in the body of at least one of the layers of the support.

The presence of security elements in a sheet according to the invention can make it possible to obtain essentially opaque zones without however having to execute imprints on the sheet. This can, for that reason, constitute an alternative to the standard imprints executed on plastic supports according to the prior art.

At least one security element, for example in the form of a thread, can also be incorporated between two layers, between a skin layer and the core layer.

The two skin layers can each comprise a security element, the security element of the first surface layer being different from the security element of the second skin layer.

At least one security element can be in tape or thread form.

At least one security element can be a security thread, a foil, a patch, a strip, pseudo-watermark, a knitted thread, marking particles referred to as “taggants”, security fibers and/or a combination of such elements.

As examples of marking particles, the following combinations can in particular be cited:

a) Altair pigment from VERISMO LLC placed in a layer facilitating printing, for example a surface layer comprising a coating and,

b) Datatrace DNA pigment from DATATRACE placed in the surface layer or layers,

or
when the support comprises at least two surface layers,

a) Spot Tag pigment from BSECURE placed in one of the surface layers and,

b) Altair pigment from VERISMO LLC placed in the other surface layer.

In general, the security element can be selected from the following marking particles:
Spot tag from BSECURE,
Datatrace DNA from DATATRACE,
black powders from MICROTAG,
IR Regulus 93, IR Regulus 39, Lanthanide derivative, Sirius or Altair from VERISMO,
“taggants” marketed by PAYNE SECURITY.

The security elements, in particular in the form of marking particles, can be present in a variable concentration within the core layer and/or at least one skin layer and/or a coating. The detection of the security elements present in the sheet, in particular in the form of marking particles, can in particular depend on the concentration of these security elements but also on the distance separating the security elements from the detection device.

FIG. 16 represents an example of a sheet according to the invention, wherein the skin layers 11 and 12 comprise marking particles 60. The presence of marking particles 60 in a skin layer makes it possible to render the marking particles 60 more accessible to a reader and to facilitate the detection thereof. Further, the quantity of marking particles necessary in a skin layer is small, which makes it possible to limit costs.

The example of FIG. 16 represents marking particles 60 present in the two skin layers 11 and 12, at the front and back of the sheet 5, which can enable the detection of the marking particles 60 from both faces of the sheet 5. As a modification, the marking particles 60 can be situated solely in a single skin layer, and the authentication of the sheet 5 can be effected solely from the face of the sheet 5 where this skin layer appears.

In the example of FIG. 16, only one face of the sheet 5 has been compacted, for example by means of moulds represented in FIG. 2b, 2c, 2e or 2f. As a modification, both faces of the sheet 5 can be compacted, as represented for example in FIG. 17.

FIG. 17 represents another example of a sheet 5 according to the invention, wherein the marking particles 60 are incorporated into the core layer 10. In particular, the quantity of marking particles 60 introduced into the core layer 10 can be defined such that the detection of the marking particles 60 is only possible in the zone made transparent Z.

In fact, the compaction of the substrate 6 at the zone made transparent Z can make it possible to increase the concentration of marking particles 60 locally, in such a way that the quantity of marking particles 60 can be such that the detection threshold for these is not reached in the non-compacted zones of the substrate 6 (outside the zone made transparent Z), and is reached in the zone made transparent Z. Marking particles 60 being present in the core layer 10, the detection can be effected from both faces of the sheet 5.

The security sheet 5 can further, according to one embodiment of the invention, comprise security elements 30, situated respectively at the front and back of the sheet 5, at the zone made transparent Z.

In the example of FIG. 17, both faces of the sheet 5 have been compacted, for example by means of moulds represented in FIG. 2a or 2d. As a modification, only one face of the sheet 5 can be compacted, as represented for example in FIG. 16.

At least one security element can further correspond to an authentication and/or identification element selected from at least one of the following elements: an element for detecting a forgery, in particular visible and/or detectable by means of a specific detection device, an element with variable, interference and/or diffractive, holographic, iridescent or liquid crystal optical effect, a magnetic or crystalline coating, magnetic fibers, tracers detectable by magnetic resonance, tracers detectable by X-ray fluorescence, biomarkers, a varnish or an ink, luminescent, fluorescent or phosphorescent tracers, photochromic, thermochromic, electroluminescent and/or piezochromic compounds and/or those which change color on contact with one or more predefined chemical or biochemical products, or electronic devices, in particular RFID.

At least one security element can be selected from fibers and/or inks and/or pigments that are luminescent, for example visible solely under UV or laser radiation, and/or iridescent, magnetic and/or metallic fibers and mixtures thereof. Preferably, such a security element will be present in the body of the base layer and/or in the body of a surface layer and/or a coating.

At least one security element can be a thermochromic, piezochromic or photochromic element.

At least one security element can be a luminescent, in particular fluorescent, particle.

At least one security element can be a marking particle containing a fragment of DNA.

The sheet can comprise all types of security element, on the surface in particular.

At least one security element can be a metallic film which is partially demetallized and/or exhibits visual, for example holographic, effects situated at the surface of the support.

At least one security element can be a metallic layer situated at the surface of at least one part of the support. In particular, the metal layer can be partially covered by an opaque layer, in order to form motifs.

At least one security element can be a motif formed of zones which are more translucent than the support and appear as a watermark, executed for example according to the method described in the patent application EP 1 518 661.

At least one security element can be a flat element of a specific material which collects light (“waveguide”) situated at the surface of the support. Such luminescent light-collecting materials which can be suitable are for example polymer films based on polycarbonate, referred to as LISA and marketed by BAYER.

Preferably the fiat element, made of a specific material which collects light comprises engraved, embossed or printed motifs, in particular in negative relief in the surface, making it possible to observe the luminescence at least at the motifs.

### SUGGESTED EXAMPLES

### Example 1

Reference is made to examples 1 to 4 described in EP 0 470 760 A2. The corresponding sheets are compressed hot, in a press such as that represented in FIG. 2, in order to form a pseudo-watermark. A sheet comprising a compacted zone as represented in FIGS. 3 to 6 is then obtained.

### Example 2

A POLYART® HS 90 or POLYART® HS 115 sheet, from ARJOBEX, comprising a porous central layer and two skin layers, is made. The pigment Datatrace DNA from DATATRACE is incorporated in the master batch of the skin layers. A coating facilitating printing is deposited on both sides of the support. In the coating of the first face, the pigment Altaïr from VERISMO LLC has previously been introduced. In the coating of the second face, fluorescent fibers and hi-lites have been introduced.

A located imprint of two complementary motifs represented in FIGS. 13 and 14 is executed on a defined zone of the coated POLYART® support.

On said defined zone, the base is compacted by placing two relief moulds in contact at a pressure of 250 bars and a temperature of 70° C. A compacted zone such as is shown in FIGS. 3 to 6 is obtained.

According to one modification, the printing can be effected after compaction.

Of course, the invention is not limited to the practical examples which have just been described.

In particular, the execution of a pseudo-watermark by compression as has just been described can be combined with the execution of a pseudo-watermark by embossing, as illustrated in FIGS. 8 and 9.

In FIG. 8, the zones made transparent 20 and 21 could also be compacted to differing extents, and the support could comprise at the zones 20 and 21 an underlying imprint (of the “see-through” type thr example), making it possible to observe the imprint differently depending on the degree of transparentization of the zones 20 and 21.

On these, the support 6, apart from the first zone 21 made transparent executed by compression of the support 6 as described above, comprises a second zone 20 made transparent by embossing of the support 6. Two security elements can at least partially cover the zones 20 and 21 on the front and the back of the substrate 6.

In the foregoing examples, the support 6 can be colored. In this way, it is possible to make a darker color appear in the zone made transparent, observed for example at a part 40 of the zone made transparent, for example when the support is coated.

The expression “comprising one” should be understood as being synonymous with “comprising at least one”, unless the contrary is specified.

1. A method for manufacturing a sheet comprising a support made from at least one polymeric material, comprising:
a) compacting at least one zone of the support so as to form at least one zone made transparent, then
b) providing the support with at least two security elements respectively at the front and the back of the support, said at least two security elements being superposed each at least partially onto said at least one zone made transparent and being positioned such that the location of one is a function of the location of the other.

2. The method as claimed in claim 1, said at least one zone made transparent being entirely situated between the planes respectively defined by the front and back faces of the support before compaction.

3. The method as claimed in claim 1, the support being not coated after compaction.

4. The method as claimed in one of claim 1, the support being coated before compaction.

5. The method as claimed in claim 1, the support being coextruded, made from at least one polymeric material comprising a core layer and at least one skin layer, the core layer comprising voids, and the method comprising, before the step a), stretching the support.

6. The method as claimed in any claim 1, the support being colored and/or comprising a luminescent agent.

7. The method as claimed in claim 1, the compaction, of the support being effected to differing extents so as to obtain different levels of transparency over the zone made transparent.

8. The method as claimed in claim 1, further comprising effecting a compaction in a zone not superposed onto the security elements.

9. The method as claimed in claim 1, the security elements being imprints.

10. The method as claimed in claim 1, the compaction of the support being obtained by a compression.

11. The method as claimed in claim 10, the first and second moulds respectively comprising first and second motifs, the first motif having raised areas of the same height relative to those of the second motif.

12. The method as claimed in claim 10, the first and second moulds respectively comprising first and second motifs, the first motif having raised areas of variable height.

13. The method as claimed in claim 5, at least one skin layer and/or the core layer comprising marking particle.

14. A method for manufacturing a sheet comprising a support, in particular at least partially opaque and/or translucent, made from at least one polymeric material, comprising compacting at least one zone of the support so as to cause the appearance of a multitone watermarked effect exhibiting different degrees of light and dark zones.

15. The manufacturing method as claimed in claim 14, said at least one zone of the support being compacted in accordance with a raster.

16. Method for manufacturing a sheet comprising a support made from at least one polymeric material, comprising:
a) coating the support, and then
b) compacting at least one zone of the support so as to form at least one zone made transparent.

17. An article comprising a sheet obtained by the method as claimed in claim 1, this article being selected from: an identity document, a means of payment such as a check or a bank note, an identity card, a passport page or booklet, a visa, a ticket, a protective or authenticating label, a traceability label, headed paper or paper for advertising purposes.

18. The method of claim 10, the compaction of the support being obtained by a compression, wherein the support is compressed between a first mould comprising a first raised motif and a second mould comprising or not comprising a second raised motif.

19. The method of claim 1, wherein the support is at least partially opaque and/or translucent.

20. The method of claim 19, wherein the support is stretched biaxially.

21. The method of claim 6, the support being a coextruded support comprising a core layer, wherein the core layer is coloured and/or comprises a luminescent agent.

22. The method of claim 7, the compaction being a compression.

23. The method of claim 8, the compaction being an embossing.
